(19) United States
(12) Patent Application Publication
(10) Pub. No.: US 2018/0233164 A1
(43) Pub. Date: Aug. 16, 2018

(54) SOCIAL NETWORKING AND MATCHING COMMUNICATION PLATFORM AND METHODS THEREOF

(71) Applicant: BEYOND VERBAL COMMUNICATION LTD., TEL-AVIV (IL)

(72) Inventor: Yoram LEVANON, RAMAT HASHARON (IL)

(73) Assignee: BEYOND VERBAL COMMUNICATION LTD, TEL-AVIV (IL)

(21) Appl. No.: 15/507,882

(22) PCT Filed: Aug. 31, 2015
(86) PCT No.: PCT/IL15/50876

§ 371 Date: Mar. 1, 2017

Related U.S. Application Data
(60) Provisional application No. 62/044,345, filed on Sep. 1, 2014.

(51) Int. Cl. G10L 25/63; G10L 15/22

(52) U.S. Cl. CPC G10L 25/63; H04L 67/306; G10L 15/22

(57) ABSTRACT

The present invention provides system and method for configuring social networking and matching communication platform by implementing analysis of voice intonations of a first user. The system comprising an input module adapted to receive voice input and orientation reference, a personal collective emotionbase comprising benchmark tones and benchmark emotional attitudes (BEA) whilst each of the benchmark tones corresponds to a specific BEA, at least one processor in communication with a computer readable medium (CRM). The processor executes a set of operations received from CRM. The set of operations comprises a step of evaluating, determining and presenting a matching rating of said user and matching the rating to another user to matching.

### FIELD OF THE INVENTION

The present invention relates to methods and system for configuring networking and matching communication platform of an individual by evaluating manifestations of physiological change in the human voice. More specifically, this embodiment of the present invention relates to methods and system for configuring networking and matching communication platform of an individual by evaluating emotional attitudes based on ongoing activity analysis of different vocal categories.

### BACKGROUND OF THE INVENTION

Recent technologies have enabled the indication of emotional attitudes of an individual, either human or animal, and linking them to ones voice intonation. For example, U.S. Pat. No. 8,078,470 discloses means and method for indicating emotional attitudes of a individual, either human or animal, according to voice intonation. The invention also discloses a system for indicating emotional attitudes of an individual comprising a glossary of intonations relating intonations to emotions attitudes. Furthermore, U.S. Pat. No. 7,917,366 discloses a computerized voice-analysis device for determining an SHG profile (as described therein, such an SHG profile relates to the strengths (e.g., relative strengths) of three human instinctive drives). Of note, the invention may be used for one or more of the following: analyzing a previously recorded voice sample; real-time analysis of voice as it is being spoken; combination voice analysis that is, a combination of: (a) previously recorded and/or real-time voice; and (b) answers to a questionnaire.

A review of existing Internet social networking sites reveals a need for a platform that utilizes said technologies by providing an easy to use, automated matching feedback mechanism by which each social networking participant can be matched to the other user. Such evaluations would be useful not only to the users themselves, but to other people who might be interested in matching to one of the users.

In light of the above, there is a long term unmet need to provide such social networking and matching communication platform implementing analysis of voice intonations and providing such an automated matching feedback mechanism to match between users.

### SUMMARY OF THE INVENTION

It is hence one object of this invention to disclose a social networking and matching communication platform capable of implementing analysis of voice intonations and providing such an automated matching feedback mechanism to match between matching users. Briefly, a matching user can be evaluated by manifestations of physiological change in the human voice based on four vocal categories: vocal emotions (personal feelings and emotional well-being in a form of offensive/defensive/neutral/indecisive profile, with the ability to perform zoom down on said profiles) of users; vocal personalities (set of user's moods based on SHG profile) of users; vocal attitudes (personal emotional expressions towards user's point/subject of interest and mutual ground of interests between two or more users) of users; and vocal imitation of two or more users. Moreover, a matching user can be evaluated based on manifestations of physiological change in the human voice and user's vocal reaction to his/her point/subject of interest through a predetermined period of time. The Internet matching system in accordance with the present invention processes the evaluation and determines a matching rating and sends the rating to the other participant to the matching by, for example, email or short message service (SMS). The evaluations and ratings may also be stored in an emotionbase for later review by the participants and/or other interested people. Advantageously, the system may also prompt the participants to take further action based on that rating. For example, if a user rates a matching positively, the system may prompt the participant to send a gift to the other participant, send a message to the other participant, or provide suggestions to that participant another matching. A user receiving a positive rating may be likewise prompted by the system.

In yet another aspect of the present invention to disclose configuring social networking and matching communication platform by implementing analysis of voice intonations of a first user, said system comprising (1) an input module, said input module is adapted to receive voice input and orientation reference selected from a group consisting of matching, time, location, and any combination thereof; (2) a personal collective emotionbase; said emotionbase comprising benchmark tones and benchmark emotional attitudes (BEA), each of said benchmark tones corresponds to a specific BEA; (3) at least one processor in communication with a computer readable medium (CRM), said processor executes a set of operations received from said CRM, said set of operations comprising steps of (a) obtaining a signal representing sound volume as a function of frequencies from said volume input; (b) processing said signal so as to obtain voice characteristics of said individual, said processing includes determining a Function A; said Function A being defined as the average or maximum sound volume as a function of sound frequencies, from within a range of frequencies measured in said volume input; said processing further includes determining a Function B; said Function B defined as the averaging, or maximizing of said function A over said range of frequencies and dyadic multiples thereof; (c) comparing said voice characteristics to said benchmark tones; (d) allocating to said voice characteristics at least one of said BEAs corresponding to said benchmark tones; and (e) assigning said orientation reference to said allocated at least one of said BEAs. It is in the core of the invention wherein said set of operations additionally comprises a step of evaluating, determining and presenting, a matching rating of said user and matching the rating to another user to matching. Said matching, for example, can be analyzed and established through combination of user's vocal expression and opinion, after presenting to him/her a series of pictures for a predetermined period of time.

In another aspect of the present invention, the system enables a participant to authorize members of the Internet website system to view his or her matching evaluation. In that way, other members may consider that evaluation in deciding whether to arrange a matching with the reviewed participant.

In yet another aspect of the present invention, the system may be linked to an established Internet matching website to provide that website with the features described herein. Alternatively, the system may be linked to blogs (weblogs) or social networking sites such as Facebook, Twitter, Xanga, Tumblr, TagWorld, Friendster, and LinkedIn.

In yet another aspect of the present invention, a widget is provided as a user-interface.

In yet another aspect of the present invention, a physical feedback (smell, touch, vision, taste) of matching intensity between two or more users is provided as a notification via mobile and/or computer platform.

### BRIEF DESCRIPTION OF THE FIGURES

In the following detailed description of the preferred embodiments, reference is made to the accompanying drawings that form a part hereof, and in which are shown by way of illustration specific embodiments in which the invention may be practiced. It is understood that other embodiments may be utilized and structural changes may be made without departing from the scope of the present invention. The present invention may be practiced according to the claims without some or all of these specific details. For the purpose of clarity, technical material that is known in the technical fields related to the invention has not been described in detail so that the present invention is not unnecessarily obscured.

FIG. 1 schematically presents a system according to the present invention;

FIG. 2 is a flow diagram illustrating a method for configuring social networking and matching communication platform;

FIG. 3 presents schematically the main software modules in a system according to the present invention.

FIG. 4 presents schematically presents a system according to the present invention in use.

FIG. 5 and FIG. 6 elucidate and demonstrate intonation and its independence of language.

### DETAILED DESCRIPTION OF THE INVENTION

In the following detailed description of the preferred embodiments, reference is made to the accompanying drawings that form a part hereof, and in which are shown by way of illustration specific embodiments in which the invention may be practiced. It is understood that other embodiments may be utilized and structural changes may be made without departing from the scope of the present invention. The present invention may be practiced according to the claims without some or all of these specific details. For the purpose of clarity, technical material that is known in the technical fields related to the invention has not been described in detail so that the present invention is not unnecessarily obscured.

The term “word” refers in the present invention to a unit of speech. Words selected for use according to the present invention usually carry a well defined emotional meaning. For example, “anger” is an English language word that may be used according to the present invention, while the word “regna” is not; the latter carrying no meaning, emotional or otherwise, to most English speakers.

The term “tone” refers in the present invention to a sound characterized by a certain dominant frequencies. Several tones are defined by frequency in Table 1 of US 2008/0270123, where shown that principal emotional values can be assigned to each and every tone. Table 1 divides the range of frequencies between 120 Hz and 240 Hz into seven tones. These tones have corresponding harmonics in higher frequency ranges: 240 to 480, 480 to 960 Hz, etc. Per each tone, the table describes a name and a frequency range, and relates its accepted emotional significance.

The term “intonation” refers in the present invention to a tone or a set of tones, produced by the vocal chords of a human speaker or an animal. For example the word “love” may be pronounced by a human speaker with such an intonation so that the tones FA and SOL are dominant.

The term “dominant tones” refers in the present invention to tones produced by the speaker with more energy and intensity than other tones. The magnitude or intensity of intonation can be expressed as a table, or graph, relating relative magnitude (measured, for example, in units of dB) to frequency (measured, for example, in units of HZ.)

The term “reference intonation”, as used in the present invention, relates to an intonation that is commonly used by many speakers while pronouncing a certain word or, it relates to an intonation that is considered the normal intonation for pronouncing a certain word. For example, the intonation FA SOL may be used as a reference intonation for the word “love” because many speakers will use the FA-SOL intonation when pronouncing the word “love”.

The term “emotional attitude”, as used in the present invention, refers to an emotion felt by the speaker, and possibly affecting the behavior of the speaker, or predisposing a speaker to act in a certain manner. It may also refer to an instinct driving an animal. For example “anger” is an emotion that may be felt by a speaker and “angry” is an emotional attitude typical of a speaker feeling this emotion.

The term “emotionbase”, as used in the present invention, refers to an organized collection of human emotions. The emotions are typically organized to model aspects of reality in a way that supports processes requiring this information. For example, modeling archived assigned referenced emotional attitudes with predefined situations in a way that supports monitoring and managing one's physical, mental and emotional well-being, and subsequently significantly improve them.

The term “configure”, as used in the present invention, refers to designing, establishing, modifying, or adapting emotional attitudes to form a specific configuration or for some specific purpose, for example in a form of collective emotional architecture.

The term “user” refers to a person attempting to configure or use one's social networking and matching communication platform capable of implementing analysis of voice intonations and providing such an automated matching feedback mechanism to match between matching participants based on ongoing activity analysis of three neurotransmitter loops, or SHG profile.

The term “SHG” refers to a model for instinctive decision-making that uses a three-dimensional personality profile. The three dimensions are the result of three drives: (1) Survival (S)—the willingness of an individual to fight for his or her own survival and his or her readiness to look out for existential threats; (2) Homeostasis (H) [or “Relaxation”]—the extent to which an individual would prefer to maintain his or her ‘status quo’ in all areas of life (from unwavering opinions to physical surroundings) and to maintain his or her way of life and activity; and (3) Growth (G)—the extent to which a person strives for personal growth in all areas (e. g., spiritual, financial, health, etc.). It is believed that these three drives have a biochemical basis in the brain by the activity of three neurotransmitter loops: (1) Survival could be driven by the secretion of adrenaline and noradrenalin; (2) Homeostasis could be driven by the secretion of acetylcholine and serotonin; (3) Growth could be driven by the secretion of dopamine. While all human beings share these three instinctive drives (S,H,G), people differ in the relative strengths of the individual drives. For example, a person with a very strong (S) drive will demonstrate aggressiveness, possessiveness and a tendency to engage in high-risk behavior when he or she is unlikely to be caught. On the other hand, an individual with a weak (S) drive will tend to be indecisive and will avoid making decisions. A person with a strong (H) drive will tend to be stubborn and resistant to changing opinions and/or habits. In contrast, an individual with a weak (H) drive will frequently change his or her opinions and/or habits. Or, for example, an individual with a strong (G) drive will strive to learn new subjects and will strive for personal enrichment (intellectual and otherwise). A weak (G) drive, on the other hand, may lead a person to seek isolation and may even result in mental depression.

The term “matching intensity level” refers to a level of two or more users vocal compatibility with each other based on four vocal categories: vocal emotions (personal feelings and emotional well-being in a form of offensive/defensive/neutral/indecisive profile, with the ability to perform zoom down on said profiles) of users; vocal personalities (set of user's moods based on SHG profile) of users; vocal attitudes (personal emotional expressions towards user's point/subject of interest and mutual ground of interests between two or more users) of users; and vocal imitation of two or more users.

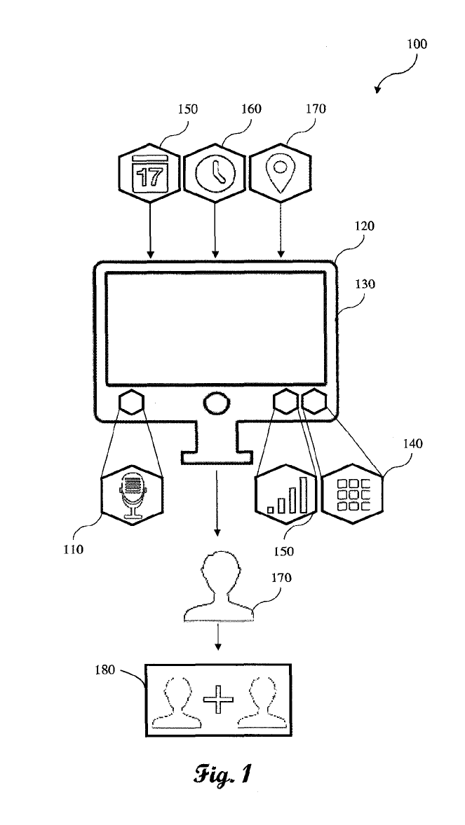

The principles, systems and methods for determining the emotional subtext of a spoken utterance used in this invention are those disclosed by Levanon et al. in PCT Application WO 2007/072485; a detailed description of their method of intonation analysis may be found in that source. Reference is made to FIG. 1, presenting a schematic and generalized presentation of the basic method for concurrently transmitting a spoken utterance and the speaker's emotional attitudes as determined by intonation analysis [100]. An input module [110] is adapted to receive voice input and orientation reference selected from a group consisting of: matching [150], time [160], location [170] and converts sound into a signal such as an electrical or optical signal, digital or analog. The voice recorder typically comprises a microphone. The signal is fed to computer or processor [120] running software code [150] which accesses a emotionbase [140]. According to one embodiment of the system, the computer comprises a personal computer. According to a specific embodiment of the present invention the computer comprises a digital signal processor embedded in a portable device. Emotionbase [140] comprises definitions of certain tones and a glossary relating tones to emotions, stores and archives said emotions. Processing comprises calculating a plurality of dominant tones, and comparing said plurality of dominant tones to a plurality of normal dominant tones specific to a word or set of words pronounced by said individual [170] so as to indicate at least one emotional attitude of said individual [170]. The results of the computation and signal processing are displayed by indicator [130] connected to the computer. According to one specific embodiment of the present invention, the indicator [130] comprises a visual display of text or graphics. According to another specific embodiment of the present invention, it comprises an audio output such as sounds or spoken words. The results of the computation are used for evaluating, determining and presenting a matching rating of said user and matching the rating to another user to matching [180].

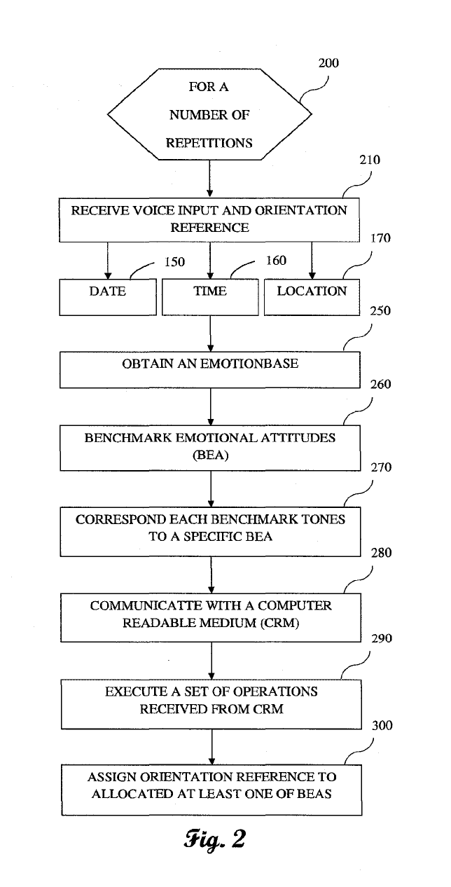

Reference is now made to FIG. 2, presenting a flow diagram illustrating a method for configuring collective emotional architecture of an individual. Said method comprises, for a predetermined number of repetitions [200], steps of receiving voice input and an orientation reference [210] selected from a group consisting of matching [150], time [160], location [170], and any combination thereof; obtaining an emotionbase [250]; said emotionbase comprising benchmark tones and benchmark emotional attitudes (BEA) [260], each of said benchmark tones corresponds to a specific BEA [270]; at least one processor in communication with a computer readable medium (CRM) [280], said processor executes a set of operations received from said CRM [290]; said set of operations are: (1) obtaining a signal representing sound volume as a function of frequency from said volume input; (2) processing said signal so as to obtain voice characteristics of said individual, said processing includes determining a Function A; said Function A being defined as the average or maximum sound volume as a function of sound frequency, from within a range of frequencies measured in said volume input; said processing further includes determining a Function B; said Function B defined as the averaging, or maximizing of said function A over said range of frequencies and dyadic multiples thereof; (3) comparing said voice characteristics to said benchmark tones; and (4) allocating to said voice characteristics at least one of said BEAs corresponding to said benchmark tones; wherein said method additionally comprises a step of assigning said orientation reference to said allocated at least one of said BEAs [300].

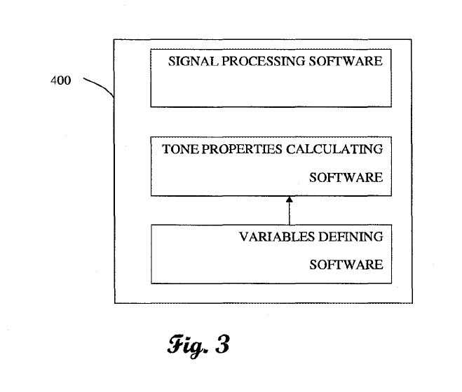

Reference is now made to FIG. 3, presenting a schematic and generalized presentation of the software [150] of the aforementioned system for communicating emotional attitudes of an individual through intonation. For the sake of clarity and brevity, infrastructure software, e.g. the operating system, is not described here in detail. The relevant software comprises three main components: (1) the signal processing component processes the audio signal received from the recorder and produces voice characteristics such as frequency, amplitude and phase; (2) the software component responsible for tonal characteristics calculations identifies the frequency ranges in which sound amplitude reaches maximum levels, and compares them to reference values found in a glossary of words and tones stored in the emotionbase; and (3) the variable definition software component, which defines the intonation specific to the individual [170] and defines the individual's [170] emotional attitudes accordingly.

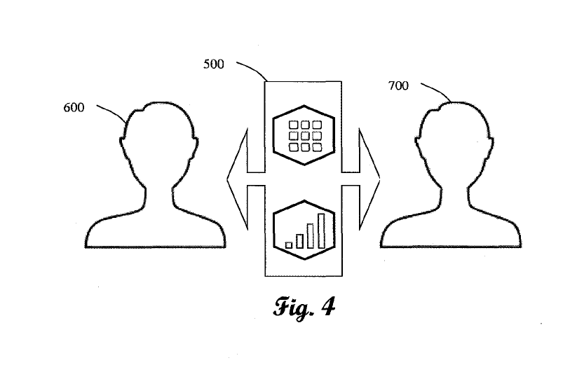

Reference is now made to FIG. 4, presenting a schematic and generalized presentation of the aforementioned novel system social networking and matching communication platform capable of implementing analysis of voice intonations and providing such an automated matching feedback mechanism to match between matching participants through evaluating, determining and presenting a matching rating of said user and matching the rating to another user to matching [500]. A profile of a first user [600] is utilized to help determine whether the first user and a second user are compatible with one another accordingly to their BEAs stored in their personal emotionbase and a profile of the second user [700] is utilized to help determine whether the second user and a first user are compatible with one another accordingly to their BEAs stored in their personal emotionbase.

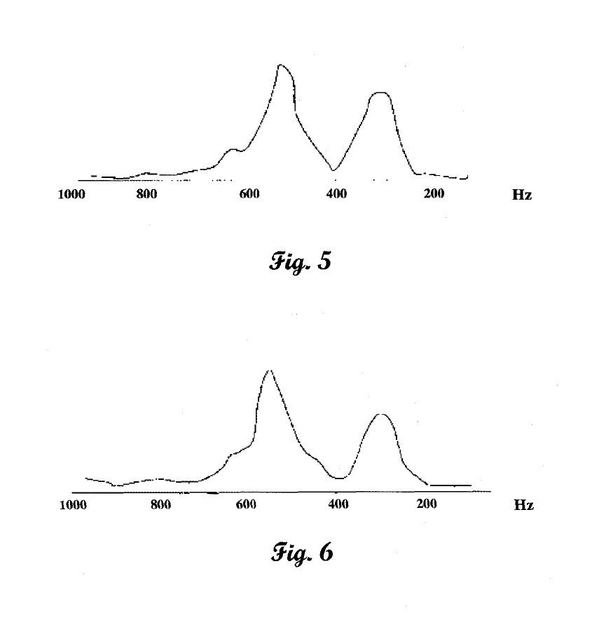

Reference is now made to FIG. 5 and FIG. 6, presenting some research data to elucidate and demonstrate the use of the present invention for indicating emotional attitudes of an individual through intonation analysis. Both figures show a graph of relative sound volume versus sound frequency from 0 to 1000 HZ. Such sound characteristics can be obtained from processing sound as described in reference to FIG. 2, by signal processing software described in reference to FIG. 3, and by equipment described in reference to FIG. 1. The graphs are the result of processing 30 seconds of speech each. Dominant tones can be identified in FIGS. 4 and 5, and the dominant tones in 5a are similar to those of 5b. Both graph result from speaking a word whose meaning is ‘love’. The language was Turkish in case of FIG. 4, and English for FIG. 5. Thus these figures demonstrate the concept on dominant tones and their independence of language.

1. A system for configuring a social networking and matching communication platform by implementing analysis of voice intonations of a first user, said system comprising:
a. an input module, said input module is adapted to receive voice input and orientation reference selected from a group consisting of: matching, time, and location corresponding to said voice input, and any combination thereof;
b. a personal collective emotionbase; said emotionbase comprising benchmark tones and benchmark emotional attitudes (BEAs), each of said benchmark tones corresponds to a specific BEA;
c. at least one processor in communication with a computer readable medium (CRM), said processor executes a set of operations received from said CRM, said set of operations comprising steps of:
i. obtaining a signal representing sound intensity as a function of frequencies from said volume input;
ii. processing said signal so as to obtain voice characteristics of said individual, said processing includes determining a Function A; said Function A being defined as the average or maximum sound volume as a function of sound frequencies, from within a range of frequencies measured in said volume input; said processing further includes determining a Function B; said Function B defined as the averaging, or maximizing of said function A over said range of frequencies and dyadic multiples thereof; and
iii. comparing said voice characteristics to said benchmark tones;
iv. assigning to said voice characteristics at least one of said BEAs corresponding to said benchmark tones;
v. assigning said orientation reference to said assigned at least one of said BEAs.
wherein said set of operations additionally comprises a step of evaluating, determining and presenting a matching rating of said user and matching the rating to another user to matching
further wherein said set of operations additionally comprises a step of archiving said at least one BEA, said orientation reference, and said matching rating to said emotionbase.

2. The system of claim 1, wherein said BEA are analyzed accordingly to four vocal categories:
a. vocal emotions (personal feelings and emotional well-being in a form of offensive/defensive/neutral/indecisive profile, with the ability to perform zoom down on said profiles) of users;
b. vocal personalities (set of user's moods based on SHG profile) of users;
c. vocal attitudes (personal emotional expressions towards user's point/subject of interest and mutual ground of interests between two or more users); and
d. vocal imitations.

3. (canceled)

4. The system of claim 1, wherein said archived at least one BEA is stored digitally.

5. The system of claim 3, wherein said set of operations additionally comprises a step of matching said archived assigned orientation reference and said archived at least one BEA with predefined situations.

6. The system of claim 7, wherein said set of operations additionally comprises a step of prompting actions relevant to said predicted emotional attitudes.

7. The system of claim 4, wherein said set of operations additionally comprises a step of predicting emotional attitude according to records of said matching.

8. The system of claim 4, wherein said set of operations additionally comprises a step of performing statistical analysis of said first user's profile by said system.

9. The system of claim 1, wherein said system additionally comprises an output module; said output module is adapted to provide said user a feedback regarding a possible matching rating to another user to matching.

10. The system of claim 1, wherein said operation of processing comprises identifying at least one dominant tone, and attributing an emotional attitude to said individual based on said at least one dominant tone.

11. The system of claim 1, wherein said operation of processing comprises calculating a plurality of dominant tones, and comparing said plurality of dominant tones to a plurality of normal dominant tones specific to a word or set of words pronounced by said individual so as to indicate at least one emotional attitude of said user.

12. The system of claim 1, wherein said range of frequencies are between 120 Hz and 240 Hz and all dyadic multiples thereof.

13. The system of claim 1, wherein said operation of comparing comprises calculating the variation between said voice characteristics and tone characteristics related to said benchmark tones.

14. The system of claim 2, wherein said benchmark emotional attitudes (BEA) are analyzed by evaluating manifestations of physiological change in the human voice; said evaluation is based on ongoing activity analysis of said vocal categories.

15. The system of claim 1, wherein said set of operations additionally comprises a step of receiving an indication from said first user to share information regarding at least one of said BEAs to be presented and maintained by a network-based social platform, the network-based social platform being a platform that allows said first user to communicatively couple with at least a second user with whom the first user has a pre-matching relationship that is stored in a user profile of the first user at the network-based social platform.

16. The system of claim 5, wherein said set of operations additionally comprises a step of determining whether to forward the information regarding the BEAs matching maintained by the network-based social platform to the at least second user based on the profile information of the second user.

17. The system of claim 16, wherein said set of operations additionally comprises a step of sharing, using at least one processor, the information regarding the BEAs matching with the at least second user by retrieving the information from the BEAs matching emotionbase maintained by the network-based social platform and providing the information to the at least second user.

18. The system of claim 1, wherein said set of operations additionally comprises a step of monitoring for a change to the information in the BEAs matching emotionbase.

19. The system of claim 18, wherein said set of operations additionally comprises a step of on detecting the change, updating the information shared to the at least second user.

20. A computer-readable storage medium containing a program which, when executed, performs an operation comprising:
a. monitoring emotional attitudes of a user in one or more virtual environments;
b. generating a profile of the user, based on the monitored activity, wherein the profile comprises at least one of an activity profile, a developmental profile, and a geographical profile for a predetermined period of time; and
c. by operation of one or more computer processors when executing the program and based on the generated profile, modifying, for the user, a social matching element to at least one of a second other user;
wherein the social element is specific to the user.

21. A social networking and matching communication platform, said platform comprising:
a. one or more social networking, matching or communication service; and
b. a BEAs matching evaluation system capable of communicating with the one or more social networking or matching service;
wherein the evaluation system stores a BEAs matching evaluation information for one or more users of the one or more social networking or matching services; and
wherein said evaluation system comprises a widget interface that is displayed to users of the one or more social networking, matching or communication services and that provides access to features of said evaluation system.

22. The system of claim 1, wherein each of the steps is carried out using at least one of computer hardware and computer software.

23. The system of claim 2, wherein the output indicator of the personality profile of a first user is utilized to help determine whether the first user and a second user are compatible with one another as a group of matching interests.

24. The system of claim 23, wherein the output indicator of the personality profile of said first user and an output indicator of the personality profile of said second user are utilized to help determine whether said first user and said second user are compatible with one another as a matching group.

25. The system of claim 1, wherein said output indicator of the personality profile of said first user is presented as a matching rating.

26. The system of claim 1, wherein said system may prompt said user to receive a physical feedback (smell, touch, vision, taste, vibration) of matching intensity between two or more as a notification via mobile and/or computer platform.

27. The system of claim 23, wherein said matching rating is sent to other users by notification, email or short message service (SMS).

28. A method for configuring social networking and matching communication platform by implementing analysis of voice intonations of a first user, said method comprising steps of:
a. receiving voice input and an orientation reference selected from a group consisting of matching, time, and location corresponding to said voice input, and any combination thereof;
b. obtaining a emotionbase; said emotionbase comprising benchmark tones and benchmark emotional attitudes (BEA), each of said benchmark tones corresponds to a specific BEA;
c. at least one processor in communication with a computer readable medium (CRM), said processor executes a set of operations received from said CRM;
said set of operations are:
i. obtaining a signal representing sound intensity as a function of frequencies from said volume input;
ii. processing said signal so as to obtain voice characteristics of said individual, said processing includes determining a Function A; said Function A being defined as the average or maximum sound volume as a function of sound frequencies, from within a range of frequencies measured in said volume input; said processing further includes determining a Function B; said Function B defined as the averaging, or maximizing of said function A over said range of frequencies and dyadic multiples thereof;
iii. comparing said voice characteristics to said benchmark tones; and
iv. assigning to said voice characteristics at least one of said BEAs corresponding to said benchmark tones;
v. assigning said orientation reference to said allocated at least one of said BEAs.
wherein said method additionally comprises a step of evaluating, determining and presenting a matching rating of said user and matching the rating to another user to matching. further wherein said method additionally comprises a step of archiving said at least one BEA, said orientation reference, and said matching rating to said emotionbase.

29. The method of claim 28, wherein said BEA are analyzed accordingly to four vocal categories:
a. vocal emotions (personal feelings and emotional well-being in a form of offensive/defensive/neutral/indecisive profile, with the ability to perform zoom down on said profiles) of users;
b. vocal personalities (set of user's moods based on SHG profile) of users;
c. vocal attitudes (personal emotional expressions towards user's point/subject of interest and mutual ground of interests between two or more users); and
d. vocal imitations.

30. (canceled)

31. The method of claim 28, wherein said retrieved emotional attitudes are stored digitally.

32. The method of claim 28, wherein said set of operations additionally comprises a step of matching said archived assigned reference and said archived at least one emotional attitude with predefined situations.

33. The method of claim 32, wherein said set of operations additionally comprises a step of predicting emotional attitude according to records of said matching.

34. The method of claim 33, wherein said set of operations additionally comprises a step of prompting actions relevant to said predicted emotional attitudes.

35. The method of claim 28, wherein said system additionally comprises an output module; said output module is adapted to provide said user a feedback regarding a possible matching rating to another user to matching.

36. The method of claim 31, wherein said set of operations additionally comprises a step of performing statistical analysis of said first user's profile by said system.

37. The method of claim 28, wherein said operation of processing comprises identifying at least one dominant tone, and attributing an emotional attitude to said individual based on said at least one dominant tone.

38. The method of claim 28, wherein said operation of processing comprises calculating a plurality of dominant tones, and comparing said plurality of dominant tones to a plurality of normal dominant tones specific to a word or set of words pronounced by said individual so as to indicate at least one emotional attitude of said user.

39. The method of claim 28, wherein said range of frequencies are between 120 Hz and 240 Hz and all dyadic multiples thereof.

40. The method of claim 28, wherein said operation of comparing comprises calculating the variation between said voice characteristics and tone characteristics related to said benchmark tones.

41. The method of claim 29, wherein said benchmark emotional attitudes (BEA) are analyzed by evaluating manifestations of physiological change in the human voice; said evaluation is based on ongoing activity analysis of said vocal categories.

42. The method of claim 28, wherein said set of operations additionally comprises a step of receiving an indication from said first user to share information regarding at least one of said BEAs to be presented and maintained by a network-based social platform, the network-based social platform being a platform that allows the first user to communicatively couple with at least a second user with whom the first user has a pre-matching relationship that is stored in a user profile of the first user at the network-based social platform.

43. The method of claim 28, wherein said set of operations additionally comprises a step of determining whether to forward the information regarding the BEAs matching maintained by the network-based social platform to the at least second user based on the profile information of the second user.

44. The method of claim 41, wherein said set of operations additionally comprises a step of sharing, using at least one processor, the information regarding the BEAs matching with the at least second user by retrieving the information from the BEAs matching emotionbase maintained by the network-based social platform and providing the information to the at least second user.

45. The method of claim 27, wherein said set of operations additionally comprises a step of monitoring for a change to the information in the BEAs matching emotionbase.

46. The method of claim 43, wherein said set of operations additionally comprises a step of on detecting the change, updating the information shared to the at least second user.

47. The method of claim 27, wherein each of the steps is carried out using at least one of computer hardware and computer software.

48. The method of claim 27, wherein the output indicator of the personality profile of a first user is utilized to help determine whether the first user and a second user are compatible with one another as a group of matching interests.

49. The method of claim 46, wherein the output indicator of the personality profile of said first user and an output indicator of the personality profile of said second user are utilized to help determine whether said first user and said second user are compatible with one another as a matching group.

50. The method of claim 27, wherein said system may prompt said user to receive a physical feedback (smell, touch, vision, taste) of matching intensity between two or more as a notification via mobile and/or computer platform.

51. The method of claim 27, wherein said output indicator of the personality profile of said first user is presented as a matching rating.

52. The method of claim 48, wherein said matching rating is sent to other users by notification, email or short message service (SMS).
